(19) United States
(12) Patent Application Publication
(10) Pub. No.: US 2026/0149778 A1
(43) Pub. Date: May 28, 2026

(54) EXPANSION UNIT AND IMAGE FORMING APPARATUS

(71) Applicant: Hiroaki NIEDA, Kanagawa (JP)

(72) Inventor: Hiroaki NIEDA, Kanagawa (JP)

(73) Assignee: ETRIA CO., LTD., Yokohama (JP)

(21) Appl. No.: 19/335,894

(22) Filed: Sep. 22, 2025

(30) Foreign Application Priority Data
Nov. 22, 2024 (JP) 2024-204023

(51) Int. Cl. H04N 1/00; G06F 3/042

(52) U.S. Cl. CPC H04N 1/00538; G06F 3/0421; H04N 1/00129

(57) ABSTRACT

An expansion unit includes a first member, a second member, and a functional unit. The first member is attachable to a first lateral side of an operation panel in a lateral direction and includes a first attachment portion on one side of the first member in a fore-and-aft direction orthogonal to the lateral direction. The second member is attachable to a second lateral side opposite to the first lateral side of the operation panel in the lateral direction and includes a second attachment portion on one side of the second member in the fore-and-aft direction. The functional unit includes a third attachment portion attachable to each of the first attachment portion of the first member and the second attachment portion of the second member. The functional unit attached to the first member and the second member is disposed adjacent to the operation panel in the fore-and-aft direction.

### CROSS-REFERENCE TO RELATED APPLICATIONS

This patent application is based on and claims priority pursuant to 35 U.S.C. § 119(a) to Japanese Patent Application No. 2024-204023, filed on Nov. 22, 2024, in the Japan Patent Office, the entire disclosure of which is hereby incorporated by reference herein.

### BACKGROUND

### Technical Field

The present disclosure relates to an expansion unit and an image forming apparatus.

### Related Art

An expansion unit that is attached to an operation device of an apparatus body is known.

### SUMMARY

According to one aspect of the present disclosure, an expansion unit includes a first member, a second member, and a functional unit. The first member is attachable to a first lateral side of an operation panel in a lateral direction and includes a first attachment portion on one side of the first member in a fore-and-aft direction orthogonal to the lateral direction. The second member is attachable to a second lateral side opposite to the first lateral side of the operation panel in the lateral direction and includes a second attachment portion on one side of the second member in the fore-and-aft direction. The functional unit includes a third attachment portion attachable to each of the first attachment portion of the first member and the second attachment portion of the second member. The functional unit attached to the first member and the second member is disposed adjacent to the operation panel in the fore-and-aft direction.

According to one aspect of the present disclosure, an image forming apparatus includes an operation panel; and the above-described expansion unit that is attachable to the operation panel.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a perspective view of an image forming apparatus;

FIG. 2 is a perspective view illustrating a state in which a non-contact sensor unit has been attached to an operation panel;

FIG. 3A and FIG. 3B are views illustrating attachment of the non-contact sensor to the operation panel in FIG. 2;

FIG. 4 is a schematic perspective view illustrating a bottom portion of the operation panel in FIG. 2;

FIG. 5 is a view illustrating an example in which the non-contact sensor is located on the front side of the operation panel in FIG. 2;

FIG. 6 is a view illustrating an example in which the non-contact sensor is attached to the rear side of the operation panel and a light blocking member is attached to the front side of the operation panel in FIG. 2;

FIG. 7A, FIG. 7B, and FIG. 7C are views illustrating an example in which a numeric keypad device is attached to a first intermediate member and an integrated circuit (IC) card reader is attached to a second intermediate member;

FIG. 8A and FIG. 8B are views illustrating the relationship between an insertion hole and a positioning hole of the intermediate member of the example illustrated in FIG. 7A and FIG. 7B; and

FIG. 9A and FIG. 9B are views illustrating a modification of the intermediate member of the example illustrated in FIG. 7A and FIG. 7B.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

An example of the related art is a configuration in which a numeric keypad device serving as the expansion unit is attached to an attachment portion provided at the right side surface of the operation device.

It has been difficult to attach, to the operation device, a functional unit that is located on the front side or the rear side of the operation device and expands the function of the operation device.

According to an aspect of the present disclosure, the functional unit located on the front side or the rear side of the operation device is attachable to the operation device without an increase in size of the operation device.

Embodiments of the present disclosure will be described with reference to the drawings. It is easy for a person skilled in the art to make other embodiments by changing and modifying the embodiments of the present disclosure within the scope of the claims, and these changes and modifications are included in the scope of the claims. In the following description, the embodiments of the present disclosure are the best mode of the disclosure and it is not intended to limit the scope of the claims.

An image forming apparatus 1 including an operation panel 50 serving as an operation device to which an expansion unit according to an embodiment of the present disclosure is attachable will be described.

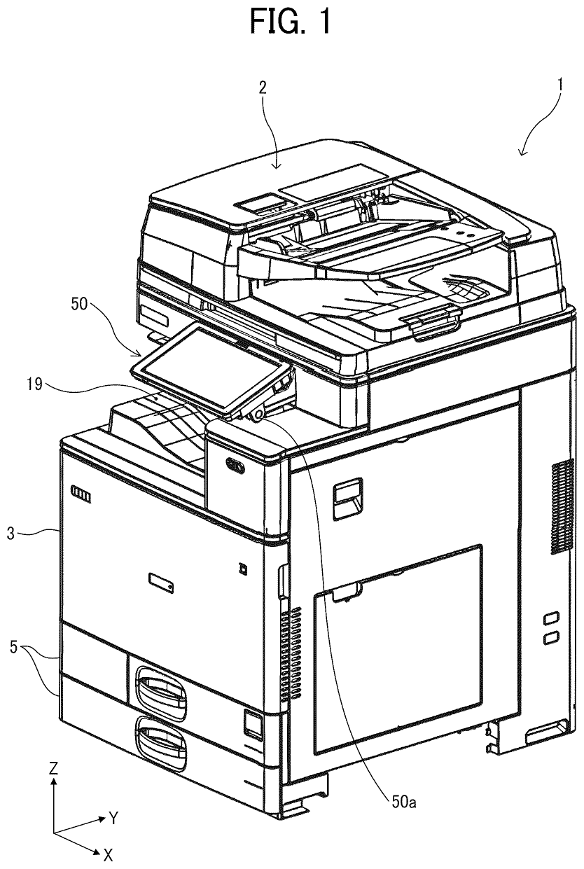

FIG. 1 is a perspective view of the image forming apparatus 1 according to the present embodiment.

The image forming apparatus 1 is a copier in which an image reading device 2 is located on an upper portion of an image forming apparatus body 3. The image forming apparatus body 3 includes a recording sheet housing portion 5 that houses a recording sheet serving as a recording medium on which an image is formed, and an image forming device (image forming unit) serving as image forming means.

The operation panel 50 is installed on a front surface (a front surface when a user performs a normal operation) of the image forming apparatus 1. The operation panel 50 serves as an input device with which the user performs various input operations relating to an image forming operation and on which information relating to the image forming operation is displayed. The operation panel 50 is rotatably supported by a support shaft 50a, so that the inclination angle of the operation panel 50 is changeable. For example, when it is difficult to see the operation screen displayed on a display 51 of the operation panel 50 for a wheelchair user or due to reflection of sunlight, the operation panel 50 can be rotated to raise the operation panel 50 (for example, the inclination angle of the operation panel 50 can be changed to 45° with respect to the horizontal direction).

The image forming device includes, for example, an exposure unit serving as exposure means, a plurality of photoconductor drums, developing devices that use toners of four colors of cyan (C), magenta (M), yellow (Y), and black (K), a transfer belt serving as an intermediate transfer body, a secondary transfer portion, and a fixing device. The image forming device forms an image, for example, in the following manner based on a read image of a document read by the image reading device 2 or print data transmitted from an external apparatus such as a personal computer (PC). The image forming device causes the exposure unit to expose the photoconductor drum of each color to light to form an electrostatic latent image on the photoconductor drum based on the print data, and causes the developing unit of each color of the developing device to supply toner onto the latent image on the photoconductor drum to develop the latent image. The image forming device primarily transfers the toner images on the photoconductor drums of the respective colors onto the transfer belt, the secondary transfer portion secondarily transfers the toner images onto a recording sheet serving as a recording medium in a superimposed manner, and then the fixing device fixes the toner images on the recording sheet by heating and pressing the toner images to form a color image. The recording sheet on which the image has been formed is ejected onto a sheet ejection tray 19 that is the upper surface of the image forming apparatus body 3.

The operation panel 50 includes a display such as a liquid crystal display (LCD) or a cathode-ray tube (CRT), and a touch panel provided to overlap the display. The touch panel is a capacitive contact sensor or a pressure-sensitive contact sensor. When a finger of the user comes into contact with a sensing surface that senses contact, the touch panel detects the contact position and detects the contact operation performed on the operation screen displayed on the display.

In recent years, in order to avoid contact with a virus or a bacterium that causes an infectious disease, there is an increasing demand for a touch panel or a button of an operation panel, which is touched by an unspecified number of users, to be operated in a non-contact manner. To meet such a demand, in the image forming apparatus, a non-contact sensor unit including a non-contact sensor that detects a non-contact operation performed by the user with respect to the operation panel is attachable to the operation panel as an option.

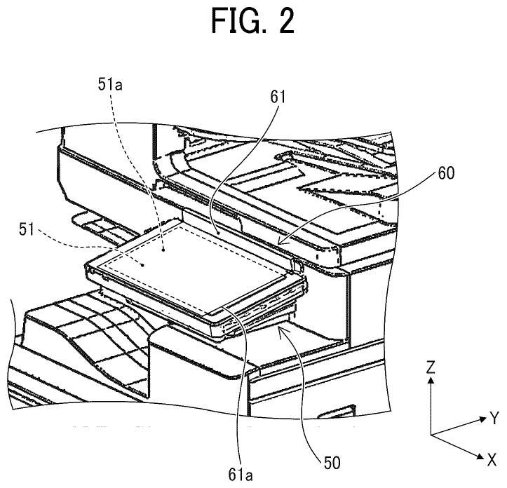

FIG. 2 is a perspective view illustrating a state in which a non-contact sensor unit 60 serving as an expansion unit has been attached to the operation panel 50.

The non-contact sensor unit 60 includes a non-contact sensor 61 serving as a functional unit. The non-contact sensor 61 is located on the rear side (+Y direction) of the operation panel 50.

In the non-contact sensor 61, optical units each including a light emitting element that emits infrared rays and a light receiving element that receives infrared rays are arranged in an array. A spatial region above a display surface 51a of the display 51, on which the operation screen is displayed, at a predetermined distance from the display surface 51a serves as a detection plane 61a that detects a non-contact operation performed by the user with respect to the operation screen. When the finger of the user enters the detection plane 61a, diffused reflected light of the infrared rays of the light emitting elements reflected from the finger is received by the plurality of light receiving elements. The position of the fingertip is detected based on the amount of infrared rays received by each of the light receiving elements, and the non-contact operation with respect to the operation screen displayed on the display 51 is detected.

The functional unit (e.g., the non-contact sensor 61) includes a non-contact sensor to detect a non-contact operation to operate the operation panel without contacting the operation panel.

A non-contact sensor of related art has two-axis scanning optical paths: a scanning optical path of infrared rays emitted in the front-rear direction of an operation panel and a scanning optical path of infrared rays emitted in the left-right direction of the operation panel.

With the non-contact sensor of the related art, light emitting elements are arranged in an array on one side of a display and light receiving elements are arranged in an array on the other side of the display. A finger that has entered a detection plane of the non-contact sensor blocks light from the light emitting elements, and the position of the finger is detected based on the position of the light receiving elements that no longer receive light. Thus, the non-contact sensor of the related art includes a frame body surrounding the display of the operation panel. It may be difficult to perform an operation at an end of the operation screen, and there is a problem in operability. In addition, there is a problem that the appearance is impaired.

In contrast, the non-contact sensor 61 according to the present embodiment has one-axis scanning optical path that is the scanning optical path of infrared rays emitted from the rear side of the operation panel 50 in the lengthwise direction (the front-rear direction, the Y direction in the drawings) of the display. Infrared rays diffused and reflected from the finger of the user entering the detection plane to the rear side of the operation panel 50 are received by the light receiving elements to detect the position of the fingertip. Thus, the non-contact sensor 61 according to the present embodiment may be located on the rear side of the operation panel 50, and the operability at the end of the operation screen can be improved as compared to the non-contact sensor of the related art surrounding the display 51. In addition, the appearance is not impaired.

Attachment portions, to which a numeric keypad device and a card reader that reads an IC card are attached, are generally provided at the right side surface and the left side surface of the operation panel 50. When an attachment portion is also provided at the rear side surface of the operation panel 50 in order to attach the non-contact sensor 61 that is located on the rear side of the operation panel 50 to the operation panel 50, the operation panel 50 is increased in size. The non-contact sensor 61 may be attached to a portion of the image forming apparatus body located rearward of the operation panel 50. However, when the operation panel 50 is rotated to change the inclination angle of the operation panel 50, the relationship between the detection plane 61a of the non-contact sensor 61 and the display surface 51a changes, and the non-contact sensor 61 may no longer detect the non-contact operation performed by the user.

Thus, according to the present embodiment, the non-contact sensor 61 is attachable to the operation panel 50 in the following manner.

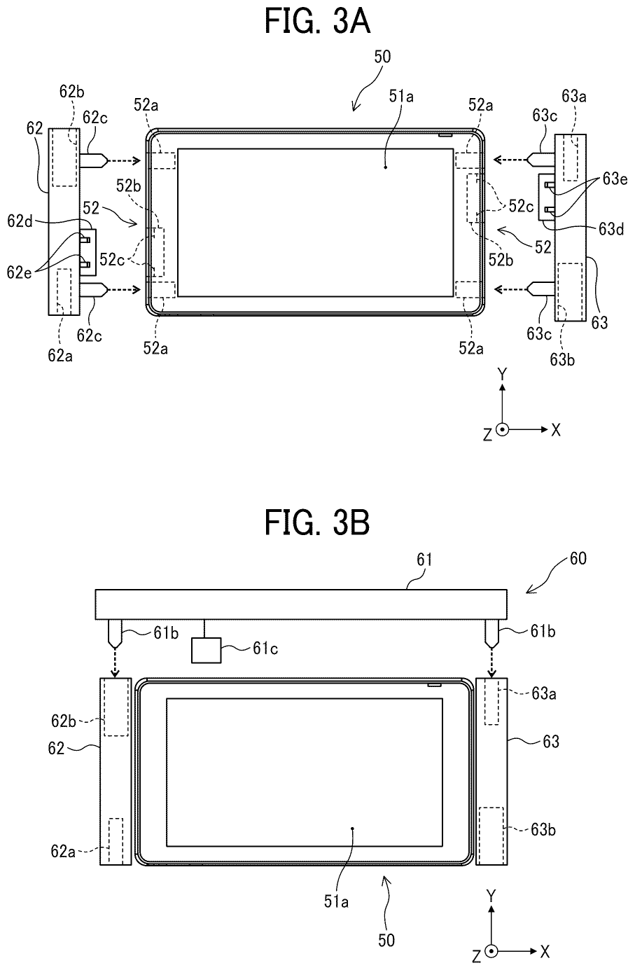

FIG. 3A and FIG. 3B are views illustrating attachment of the non-contact sensor 61 to the operation panel 50 according to the present embodiment.

The non-contact sensor unit 60 serving as the expansion unit according to the present embodiment includes a first intermediate member 62 serving as a first member and a second intermediate member 63 serving as a second member for attaching the non-contact sensor 61 to the operation panel 50. The first intermediate member 62 and the second intermediate member 63 have the same structures. Insertion holes 62a, 62b, 63a, and 63b serving as functional unit attachment portions are provided in the front side surfaces and the rear side surfaces of the first and second intermediate members 62 and 63.

The insertion hole 62b provided in the rear side surface of the first intermediate member 62 is a long hole that is long in the left-right direction and serves as a sub-reference for attachment of the non-contact sensor 61. The insertion hole 63a provided in the rear side surface of the second intermediate member 63 is a round hole and serves as a main reference for attachment of the non-contact sensor 61.

The insertion hole 62a provided in the front side surface of the first intermediate member 62 is a round hole and serves as a main reference for attachment. The insertion hole 63b provided in the front side surface of the second intermediate member 63 is a long hole that is long in the left-right direction and serves as a sub-reference for attachment.

Attachment structure portions 52 serving as attachment portions are provided at the left side surface and the right side surface of the operation panel 50. Each of the attachment structure portions 52 has positioning holes 52a provided on both sides in the front-rear direction of the side surface, and a rectangular opening 52b. The opening 52b is provided with a pair of lock pins 52c.

The first intermediate member 62 has a pair of positioning pins 62c. The second intermediate member 63 has a pair of positioning pins 63c. The pairs of positioning pins 62c and 63c are inserted into the positioning holes 52a of the attachment structure portions 52. An insertion portion 62d is provided between the positioning pins 62c. An insertion portion 63d is provided between the positioning pins 63c. The insertion portions 62d and 63d are inserted into the rectangular openings 52b of the attachment structure portion 52. The insertion portion 62d is provided with a pair of engagement members 62e. The insertion portion 63d is provided with a pair of engagement members 63e. Each of the pairs of engagement members 62e and 63e has a claw portion protruding upward at a distal end of the engagement member.

As described above, the first intermediate member 62 and the second intermediate member 63 have the same structures. The first intermediate member 62 can be used as the second intermediate member 63 by reversing the first intermediate member 62 in the left-right direction and then reversing the first intermediate member 62 in the front-rear direction.

When the positioning pins 62c and 63c of the first and second intermediate members 62 and 63 are inserted into the positioning holes 52a of the operation panel 50, the first and second intermediate members 62 and 63 are positioned at the operation panel 50. As the insertion portions 62d and 63d of the first and second intermediate members 62 and 63 are inserted, the claw portions at the distal ends of the engagement members 62e and 63e provided at the insertion portions 62d and 63d come into contact with the lock pins 52c of the openings 52b. As the insertion portions 62d and 63d are further inserted into the openings 52b from this state, the engagement members 62e and 63e are elastically deformed, and the lock pins 52c ride over the claw portions. Accordingly, the engagement members 62e and 63e engage with the lock pins 52c, and the first and second intermediate members 62 and 63 are attached to the operation panel 50.

As illustrated in FIG. 3B, the non-contact sensor 61 is attached to the operation panel 50 by being attached to the first and second intermediate members 62 and 63 attached to the operation panel 50. As illustrated in FIG. 3B, insertion pins 61b are provided on both sides in the left-right direction (longitudinal direction) of the non-contact sensor 61. The non-contact sensor 61 is attached by the insertion pins 61b being inserted into the insertion hole 63a of the second intermediate member 63 and the insertion hole 62b of the first intermediate member 62.

An expansion unit includes a first member (e.g., the first intermediate member 62) attachable to a first lateral side of an operation panel 50 in a lateral direction (e.g., the X direction), the first member including a first attachment portion (e.g., the insertion hole 62b) on one side of the first member in a fore-and-aft direction (e.g., the Y direction) orthogonal to the lateral direction; and a second member (e.g., the second intermediate member 63) attachable to a second lateral side opposite to the first lateral side of the operation panel 50 in the lateral direction (e.g., the X direction), the second member including a second attachment portion (e.g., the insertion hole 63a) on one side of the second member in the fore-and-aft direction (e.g., the Y direction). The expansion unit further includes a functional unit (e.g., the non-contact sensor 61) including a third attachment portion (e.g., the insertion pins 61b) attachable to each of the first attachment portion (e.g., the insertion hole 62b) of the first member (e.g., the first intermediate member 62) and the second attachment portion (e.g., the insertion hole 63a) of the second member (e.g., the second intermediate member 63). The functional unit (e.g., the non-contact sensor 61) attached to the first member and the second member is disposed adjacent to the operation panel 50 in the fore-and-aft direction (e.g., the Y direction).

The first member (e.g., the first intermediate member 62) has a first insertion hole (e.g., the insertion hole 62b) at the one side of the first member in the fore-and-aft direction (e.g., the Y direction). The second member (e.g., the second intermediate member 63) has a second insertion hole (e.g., the insertion hole 63a) at the one side of the second member in the fore-and-aft direction (e.g., the Y direction). The third attachment portion (e.g., the insertion pins 61b) of the functional unit (e.g., the non-contact sensor 61) includes: a first insertion pin (e.g., insertion pins 61b) insertable into the first insertion hole (e.g., the insertion hole 62b 62b) of the first member in the fore-and-aft direction; and a second insertion pin (e.g., the insertion hole 62b) insertable into the second insertion hole (e.g., the insertion hole 63a) of the second member in the fore-and-aft direction (e.g., the Y direction).

The first member includes a third insertion pin (e.g., the positioning pins 62c) insertable into a third insertion hole (e.g., the positioning holes 52a) of the operation panel 50 at the first lateral side. The second member includes a fourth insertion pin (e.g., the positioning pins 63c) insertable into a fourth insertion hole (e.g., the positioning holes 52a) of the operation panel 50 at the second lateral side.

With the following configuration, the non-contact sensor 61 may be reliably attached to the intermediate members. Specifically, an engagement member extending to the front side is provided directly below each of the insertion pins 61b of the non-contact sensor 61. Openings are provided directly below the insertion holes in the front side surface and the rear side surface of each of the first and second intermediate members 62 and 63. Lock pins are provided in the openings. The engagement members are inserted into the openings, and the engagement members are engaged with the lock pins provided in the openings. Thus, the non-contact sensor 61 is attached to the first and second intermediate members 62 and 63.

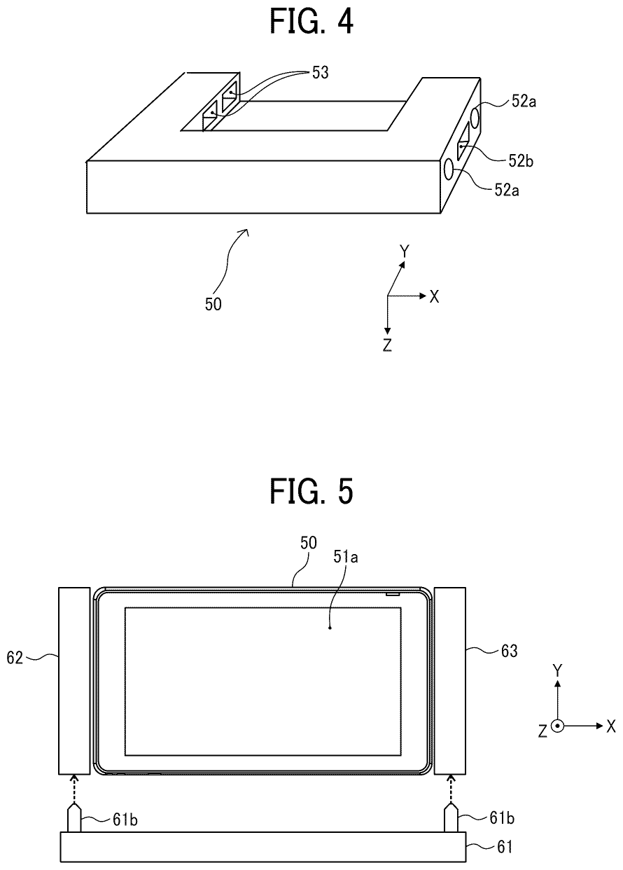

A Universal Serial Bus (USB) terminal 61c of the non-contact sensor 61 is inserted into a USB port 53 provided in a bottom portion of the operation panel 50 illustrated in FIG. 4. Accordingly, for example, communication with a panel controller that controls the operation panel 50 and power supply to the non-contact sensor 61 are performed.

In the present embodiment, the insertion holes 62a and 63a that are the round holes serving as the main references for attachment are provided on one sides of the first and second intermediate members 62 and 63 in the front-rear direction (the Y direction in the drawings), and the insertion holes 62b and 63b that are the long holes long in the left-right direction and serving as the sub-references for attachment are provided on the other sides of the first and second intermediate members 62 and 63. When the first intermediate member 62 is attached to the operation panel 50, the insertion hole 62b of the long hole is located on the rear side, and the insertion hole 62a of the round hole is located on the front side. In contrast, the second intermediate member 63 is reverse to the first intermediate member 62. The insertion hole 63a of the round hole is located on the rear side and the insertion hole 63b of the long hole is located on the front side. Accordingly, as illustrated in FIG. 5, the non-contact sensor 61 is attachable to the front side of the operation panel 50 by inserting the insertion pins 61b of the non-contact sensor 61 into the insertion holes on the front side of the first and second intermediate members 62 and 63.

The operation panel 50 is generally used in common for many models, and there may be no space in which the non-contact sensor 61 can be located on the rear side of the operation panel 50 depending on the model. Even in such a case, according to the present embodiment, the function of the operation panel 50 can be expanded so that a non-contact operation can be performed by the non-contact sensor 61 being attached to the front side of the operation panel 50.

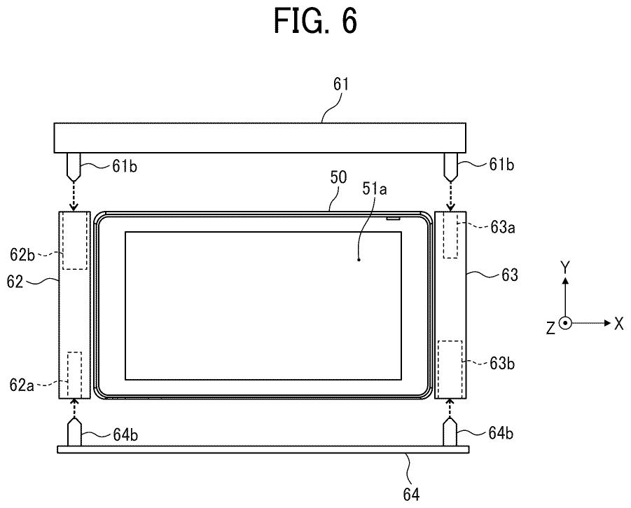

As illustrated in FIG. 6, the non-contact sensor 61 may be attached to the rear side of the operation panel 50, and a functional unit may be also attached to the front side of the operation panel 50. The functional unit that is attached to the front side illustrated in FIG. 6 is a light blocking member 64 that blocks infrared rays emitted from the non-contact sensor 61.

As described above, the non-contact sensor 61 attached to the rear side of the operation panel 50 receives, with the plurality of light receiving elements, diffused reflected infrared rays from the operating finger (indicator) that has entered the detection plane 61a (see FIG. 2), and detects the position of the operating finger based on the amount of infrared rays received by each of the light receiving elements. Thus, when a highly reflective object having a high reflectivity (for example, a plastic card such as an employee identification (ID) card) is present in front of the operation panel 50, the light receiving elements may receive infrared rays reflected from the highly reflective object and erroneously detect the infrared rays.

Since the light blocking member 64 is attached to the front side of the operation panel 50, even when a highly reflective object is located in front of the operation panel 50, the infrared rays of the light emitting elements can be prevented from being emitted on the highly reflective object. Accordingly, erroneous detection of the non-contact sensor 61 can be reduced.

Each of the first and second intermediate members 62 and 63 may have an expansion unit attachment portion to which an expansion unit such as a numeric keypad device or an IC card reader located on the right side or the left side of the operation panel 50 is attached.

The expansion unit (e.g., the non-contact sensor unit 60) further includes another functional unit (e.g., the light blocking member 64). The first member (e.g., the first intermediate member 62) has another first insertion hole (e.g., the insertion hole 62a) at another side of the first member (e.g., the first intermediate member 62) in the fore-and-aft direction (e.g., the Y direction). The second member (e.g., the second intermediate member 63) has another second insertion hole (e.g., the insertion hole 63b) at another side of the second member (e.g., the second intermediate member 63) in the fore-and-aft direction (e.g., the Y direction). The another functional unit (e.g., the light blocking member 64) includes: a third insertion pin 64b insertable into the another first insertion hole (e.g., the insertion hole 62a) of the first member (e.g., the first intermediate member 62) in the fore-and-aft direction (e.g., the Y direction); and a fourth insertion pin 64b insertable into the another second insertion hole (e.g., the insertion hole 63b) of the second member (e.g., the second intermediate member 63) in the fore-and-aft direction (e.g., the Y direction).

The functional unit includes a non-contact sensor to detect a non-contact operation performed on the operation panel, and the another functional unit (e.g., the light blocking member 64) includes a light blocking member to block infrared rays emitted from the non-contact sensor 61.

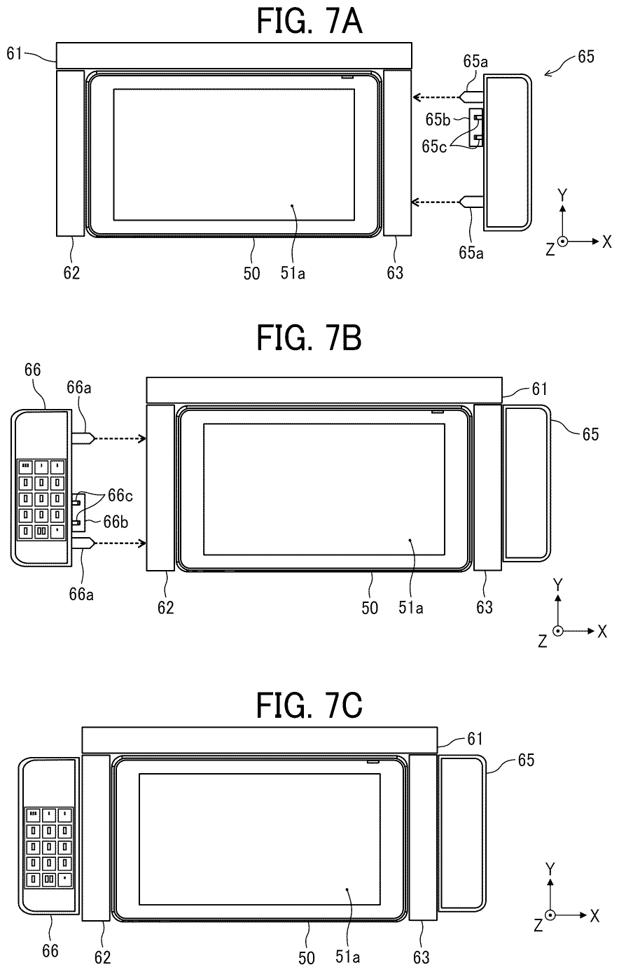

FIG. 7A is a view illustrating attachment of an IC card reader 65 to the second intermediate member 63. FIG. 7B is a view illustrating attachment of a numeric keypad device 66 to the first intermediate member 62. FIG. 7C is a schematic view of the operation panel 50 to which the non-contact sensor 61, the IC card reader 65, and the numeric keypad device 66 have been attached.

The expansion unit attachment portions provided at the first and second intermediate members 62 and 63 have the same structures as the attachment structure portions 52 (see FIG. 3A and FIG. 3B) of the operation panel 50. In other words, each of the functional unit attachment portions has a structure having positioning holes provided on both sides in the front-rear direction and a rectangular opening, and the opening is provided with a pair of lock pins.

As illustrated in FIG. 7A, positioning pins 65a of the IC card reader 65 are inserted into the positioning holes of the second intermediate member 63, and an insertion portion 65b of the IC card reader 65 is inserted into the opening of the second intermediate member 63. When a pair of engagement members 65c provided at the insertion portion 65b engage with the lock pins of the second intermediate member 63, the IC card reader 65 is attached to the right side of the operation panel 50 via the second intermediate member 63.

As illustrated in FIG. 7B, positioning pins 66a of the numeric keypad device 66 are inserted into the positioning holes of the first intermediate member 62, and an insertion portion 66b of the numeric keypad device 66 is inserted into the opening of the first intermediate member 62.

When a pair of engagement members 66c provided at the insertion portion 66b engage with the lock pins of the first intermediate member 62, the numeric keypad device 66 is attached to the left side of the operation panel 50 via the first intermediate member 62.

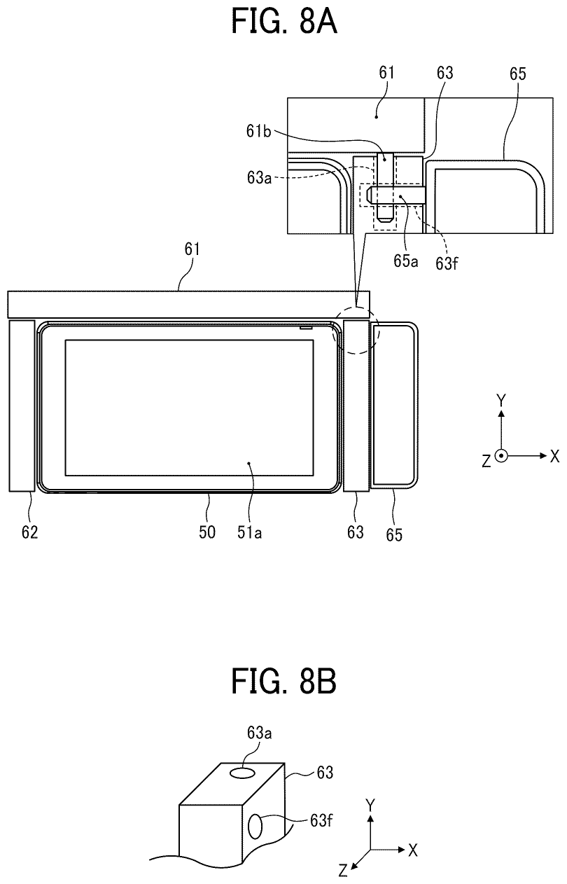

As illustrated in FIGS. 8A and 8B, in the first and second intermediate members 62 and 63 illustrated in FIGS. 7A and 7B, the insertion hole 63a into which the insertion pin 61b of the non-contact sensor 61 is inserted is provided below a positioning hole 63f into which the positioning pin 65a of the IC card reader 65 is inserted. FIG. 8B is an enlarged schematic perspective view of an end portion on the rear side of the second intermediate member 63. While FIGS. 8A and 8B illustrate the second intermediate member 63, the same applies to the first intermediate member 62. Also on the front side of each of the first and second intermediate members 62 and 63, the insertion hole 63b is provided below the positioning hole 63f into which the positioning pin 65a of the IC card reader 65 is inserted.

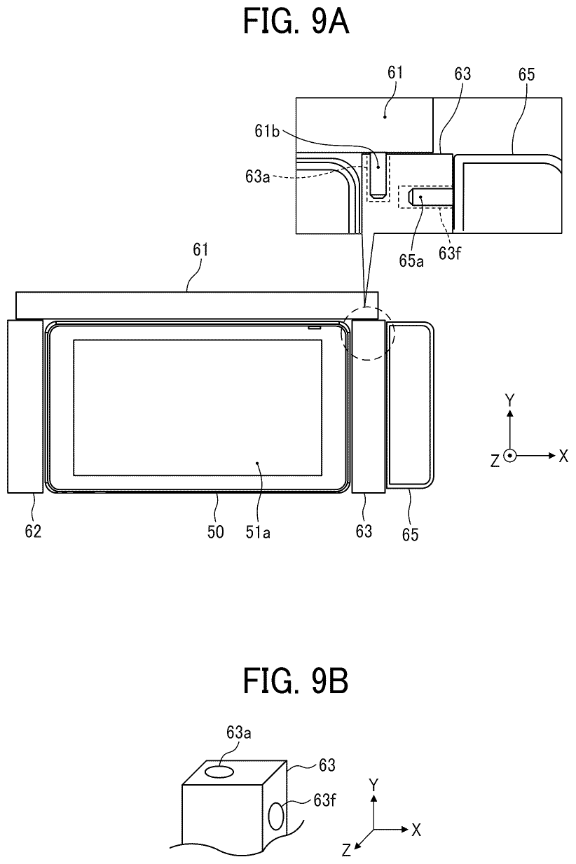

As illustrated in FIGS. 9A and 9B, each of the first and second intermediate members 62 and 63 may be elongated in the left-right direction (X direction), and the insertion hole 63a and the positioning hole 63f may be provided at the same positions in the up-down direction (Z direction). While the first and second intermediate members 62 and 63 are longer in the left-right direction with the configuration illustrated in FIGS. 9A and 9B as compared to the configuration illustrated in FIGS. 8A and 8B, the first and second intermediate members 62 and 63 can be shorter in the up-down direction and the non-contact sensor 61 can be shorter in the up-down direction as compared to the configuration illustrated in FIGS. 8A and 8B.

Although the desirable embodiments and examples of the disclosure have been described above, the disclosure is not particularly limited to such specific embodiments and examples unless otherwise particularly limited in the above description, and various modifications and changes can be made without departing from the spirit and scope of the disclosure as set forth in the appended claims. While the present disclosure is applied to the non-contact sensor unit serving as the expansion unit that is attached to the operation panel of the image forming apparatus as described above, the present disclosure is not limited to the non-contact sensor unit. The operation device to which the expansion unit according to the present disclosure is attached is not limited to the operation panel of the image forming apparatus, and may be a tablet, an operation panel of a home appliance, an operation panel of a machine tool, or the like.

The configurations described above are examples, and aspects of the present disclosure provide respective effects as follows.

### Aspect 1

According to Aspect 1, an expansion unit such as a non-contact sensor unit 60 that is attached to an operation device such as an operation panel 50 of an apparatus body includes a first member such as a first intermediate member 62 that is attached to an attachment portion such as an attachment structure portion 52 provided at a left side surface of the operation device; a second member such as a second intermediate member 63 that is attached to an attachment portion such as an attachment structure portion provided at a right side surface of the operation device; and a functional unit such as a non-contact sensor 61 that is attached to the first member and the second member, is located on a front side or a rear side of the operation device, and expands a function of the operation device.

The expansion unit that is attached to the operation device such as the operation panel 50 is, for example, a numeric keypad device or a card reader that reads an IC card. Attachment portions, to which the numeric keypad device and the card reader are attached, are generally provided at the right side surface and the left side surface of the operation device.

In recent years, in order to avoid contact with a virus or a bacterium that causes an infectious disease, there is an increasing demand for a touch panel or a button of an operation device, which is touched by an unspecified number of users, to be operated in a non-contact manner. To meet such a demand, it is desirable that the non-contact sensor that detects a non-contact operation performed by the user with respect to the operation device is attachable to the operation device as an option. It is desirable to locate the non-contact sensor on the rear side of the operation device so as not to interrupt an operation.

When an attachment portion to which an expansion unit is attached is provided also at the front side surface or the rear side surface of the operation device in order to attach, to the operation device, a functional unit such as the non-contact unit to be located on the rear side or the front side of the operation device, there is a problem that the operation device increases in size or the operation device increases in cost.

Thus, according to Aspect 1, the first member and the second member are attached to the attachment portion provided at the left side surface of the operation device and the attachment portion provided at the right side surface of the operation device, respectively, and the functional unit that is located on the front side or the rear side of the operation device is attachable to the operation device via the first member and the second member.

Accordingly, even when the attachment portion is not provided at the front side surface or the rear side surface of the operation device, the functional unit that is located on the front side or the rear side of the operation device can be attached to the operation device, and an increase in size of the operation device can be suppressed.

### Aspect 2

According to Aspect 2, in the expansion unit of Aspect 1, the functional unit includes a non-contact sensor 61 that detects a non-contact operation with respect to the operation device such as the operation panel 50.

Accordingly, since the non-contact sensor 61 is attached to the operation device, the operation device can be operated without contact on the touch panel or the button of the operation device. Thus, it is possible to meet a demand for operating, in a non-contact manner, the touch panel or the button of the operation device, which is touched by an unspecified number of users.

### Aspect 3

According to Aspect 3, in the expansion unit of Aspect 1 or 2, the first member such as the first intermediate member 62 and the second member such as the second intermediate member 63 have same structures.

Accordingly, as described in the embodiment, the first member such as the first intermediate member 62 can be used as the second member such as the second intermediate member 63, and the second member can be used as the first member.

### Aspect 4

According to Aspect 4, in the expansion unit of Aspect 3, the first member such as the first intermediate member 62 and the second member such as the second intermediate member 63 are provided with a plurality of functional unit attachment portions such as insertion holes on a front side and a rear side of the first member and the second member, the functional unit such as the non-contact sensor 61 being attachable to the plurality of functional unit attachment portions in a state in which the first member and the second member have been attached to the operation device such as the operation panel 50.

Accordingly, as described with reference to FIGS. 5 and 6, the functional units can be attached to both the front side and the rear side of the operation device such as the operation panel 50 via the first member such as the first intermediate member 62 and the second member such as the second intermediate member 63.

### Aspect 5

According to Aspect 5, in the expansion unit according to any one of Aspects 1 to 4, the first member such as the first intermediate member 62 and the second member such as the second intermediate member 63 have a plurality of expansion unit attachment portions to which an expansion unit such as a numeric keypad device 66 or an IC card reader 65 that is located on a left side or a right side of the operation device such as the operation panel 50 is attachable.

Accordingly, as described with reference to FIGS. 7A, 7B, 7C, and other drawings, the expansion unit such as the numeric keypad device 66 or the IC card reader 65 located on the left side or the right side of the operation device such as the operation panel 50 can be attached to the operation device via the first member such as the first intermediate member 62 or the second member such as the second intermediate member 63.

### Aspect 6

According to Aspect 6, in an image forming apparatus including an operation device such as an operation panel 50, the expansion unit such as the non-contact sensor unit 60 of any one of Aspects 1 to 5 is attached to the operation device.

Accordingly, the expansion unit can be located on the rear side or the front side of the operation device such as the operation panel 50 without an increase in size of the operation device such as the operation panel 50.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. An expansion unit comprising:
a first member attachable to a first lateral side of an operation panel in a lateral direction,
the first member including a first attachment portion on one side of the first member in a fore-and-aft direction orthogonal to the lateral direction;
a second member attachable to a second lateral side opposite to the first lateral side of the operation panel in the lateral direction,
the second member including a second attachment portion on one side of the second member in the fore-and-aft direction; and
a functional unit including a third attachment portion attachable to each of the first attachment portion of the first member and the second attachment portion of the second member,
wherein the functional unit attached to the first member and the second member is disposed adjacent to the operation panel in the fore-and-aft direction.

2. The expansion unit according to claim 1,
wherein the functional unit includes a non-contact sensor to detect a non-contact operation to operate the operation panel without contacting the operation panel.

3. The expansion unit according to claim 1,
wherein the first member and the second member have the same structure.

4. The expansion unit according to claim 3,
wherein the first member has a first insertion hole at the one side of the first member in the fore-and-aft direction,
the second member has a second insertion hole at the one side of the second member in the fore-and-aft direction, and
the third attachment portion of the functional unit includes:
a first insertion pin insertable into the first insertion hole of the first member in the fore-and-aft direction; and
a second insertion pin insertable into the second insertion hole of the second member in the fore-and-aft direction.

5. The expansion unit according to claim 1,
wherein the first member includes a third insertion pin insertable into a third insertion hole of the operation panel at the first lateral side, and
the second member includes a fourth insertion pin insertable into a fourth insertion hole of the operation panel at the second lateral side.

6. An image forming apparatus comprising:
an operation panel; and
the expansion unit, according to claim 1, attachable to the operation panel.

7. The expansion unit according to claim 4, further comprising another functional unit,
wherein the first member has another first insertion hole at another side of the first member in the fore-and-aft direction,
the second member has another second insertion hole at another side of the second member in the fore-and-aft direction, and
the another functional unit includes:
a third insertion pin insertable into the another first insertion hole of the first member in the fore-and-aft direction; and
a fourth insertion pin insertable into the another second insertion hole of the second member in the fore-and-aft direction.

8. The expansion unit according to claim 7,
wherein the functional unit includes a non-contact sensor to detect a non-contact operation to operate the operation panel without contacting the operation panel, and
the another functional unit includes a light blocking member to block infrared rays emitted from the non-contact sensor.
